(19) United States
(12) Patent Application Publication
(10) Pub. No.: US 2010/0170484 A1
(43) Pub. Date: Jul. 8, 2010

(54) INTERNAL COMBUSTION ENGINE HAVING A CRANKCASE FOR A PLURALITY OF CYLINDERS

(75) Inventor: Robert Berger, Strallegg (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL List GmbH

(21) Appl. No.: 12/452,667

(22) PCT Filed: Jun. 23, 2008
(86) PCT No.: PCT/EP2008/057918

§ 371 Date: Mar. 1, 2010

(30) Foreign Application Priority Data
Jul. 17, 2007 (AT) A 1130/2007

(51) Int. Cl. F02B 25/06; F02F 7/00

(52) U.S. Cl. 123/573; 123/195 R

(57) ABSTRACT

An internal combustion engine has a crankcase for a plurality of cylinders, which has hollow vertical reinforcements in the area of the side walls of the crankcase in the area of the main bearing planes, at least a part of the vertical reinforcements being implemented as oil recirculation passages between cylinder head and crankcase. At least one vertical reinforcement which conducts blow-by gas has a connection for a blow-by gas line leading to an oil separator.

The invention relates to an internal combustion engine having a crankcase for a plurality of cylinders, which has hollow vertical reinforcements of the side walls of the crankcase in the area of the main bearing planes, at least a part of the vertical reinforcements being implemented as oil recirculation passages between cylinder head and crankcase.

The publications DE 43 24 609 C2 and U.S. Pat. No. 7,225,786 B2 disclose crankcases having hollow vertical reinforcements, which function as oil recirculation channels between cylinder head and crankcase. The hollow reinforcements are connected to one another by a longitudinal channel.

In reciprocating piston internal combustion engines, because of the high pressures and the back-and-forth movement of the pistons, combustion gases enter the crankcase via the piston rings. These combustion gases, also referred to as “blow by”, increase the pressure in the crankcase, damage the lubricant oil, and make sealing the crankcase more difficult. The crankcase must therefore be ventilated. This is typically performed in that a connection is provided in the form of a ventilation line between the crankcase and the intake system of the reciprocating piston internal combustion engine. Therefore, no pollutants reach the environment. In order to keep the lubricant oil, which is contained in the crankcase gases in finely distributed form, out of the intake system of the reciprocating piston internal combustion engine, oil separators are used, preferably having filters, via which the crankcase gases are conducted before they reach the intake system of the reciprocating piston internal combustion engine. Oil separators of this type are connected via a blow-by line to the crankcase. The configuration of the removal point for the blow-by line in the crankcase decisively influences the quantity of the entrained oil components.

The object of the invention is to allow a simple removal of the blow-by gases with the least possible oil component.

This is achieved according to the invention in that at least one vertical reinforcement which conducts blow-by gas has a connection for a blow-by gas line leading to an oil separator, preferably, a first group of vertical reinforcements being implemented as oil recirculation channels and a second group of vertical reinforcements being implemented as blow-by channels, so that the oil recirculation and the flow of blow-by gases occur essentially separately from one another.

Advantageously, the first vertical reinforcements are situated on a first longitudinal side and the second vertical reinforcements are situated on a second longitudinal side of the crankcase.

To prevent excessively high oil introduction into the blow-by gas line, it is provided that the first group of vertical reinforcements are connected to oil recirculation passages in the cylinder head and the second group of vertical reinforcements are connected to blow-by gas passages in the cylinder head, the mouths of the oil recirculation channels of the cylinder head being situated lower than the mouths of the blow-by gas channels.

In a particularly advantageous embodiment variant of the invention, the vertical reinforcement having the connection for the blow-by gas line has a flow connection via a connection channel to an adjacent vertical reinforcement, the connection channel preferably being situated in the area of the cylinders in the side wall of the crankcase. The connection channel has an oil separation edge in the area of the vertical reinforcement having the connection, on the bottom side farther away from the cylinder head. Oil which possibly enters the vertical reinforcement having the connection is thus separated even before flowing into the blow-by gas line. It is preferably provided that the connection channel is implemented as an oil collection chamber, in order to conduct separated oil into the adjacent vertical reinforcement. The separated oil can reach the oil chamber of the crankcase via the connection channel and the adjacent vertical reinforcement.

It can be provided that the vertical reinforcement having the connection is separated from the cylinder head by a cylinder head seal in the area of the cylinder head sealing surface, preferably except for an oil recirculation opening. Oil and blow-by gas flowing from the cylinder in the direction of the crankcase are thus captured. It is ensured by the oil recirculation hole that oil coming from the cylinder head intentionally flows into the oil collection chamber.

Furthermore, it is advantageous to achieve good separation rates if the vertical reinforcement having the connection is situated approximately in the area of an engine central plane.

The invention is explained in greater detail hereafter on the basis of the figures. In the figures:

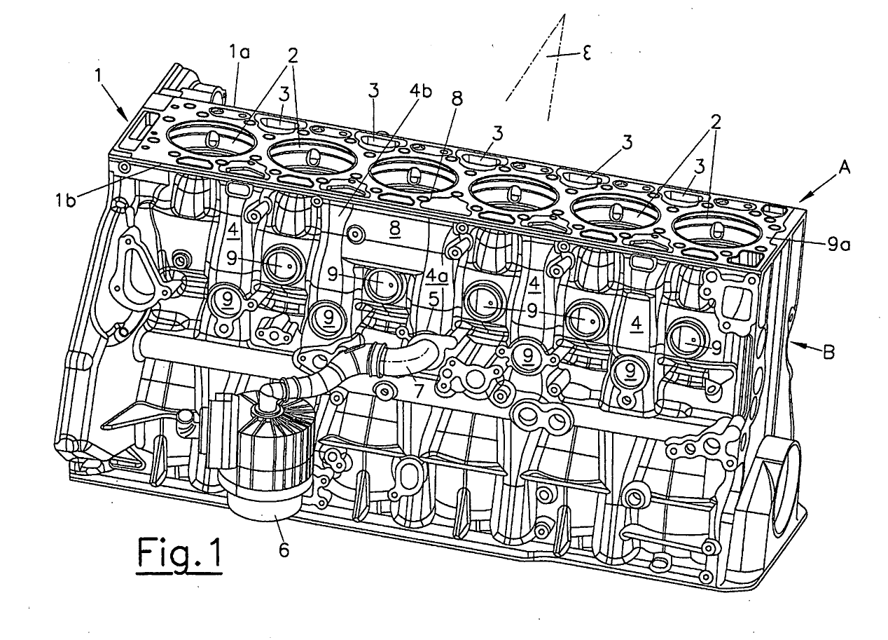

FIG. 1 shows a crankcase of an internal combustion engine according to the invention in a diagonal view including blow-by gas line and oil separation device in a first embodiment variant;

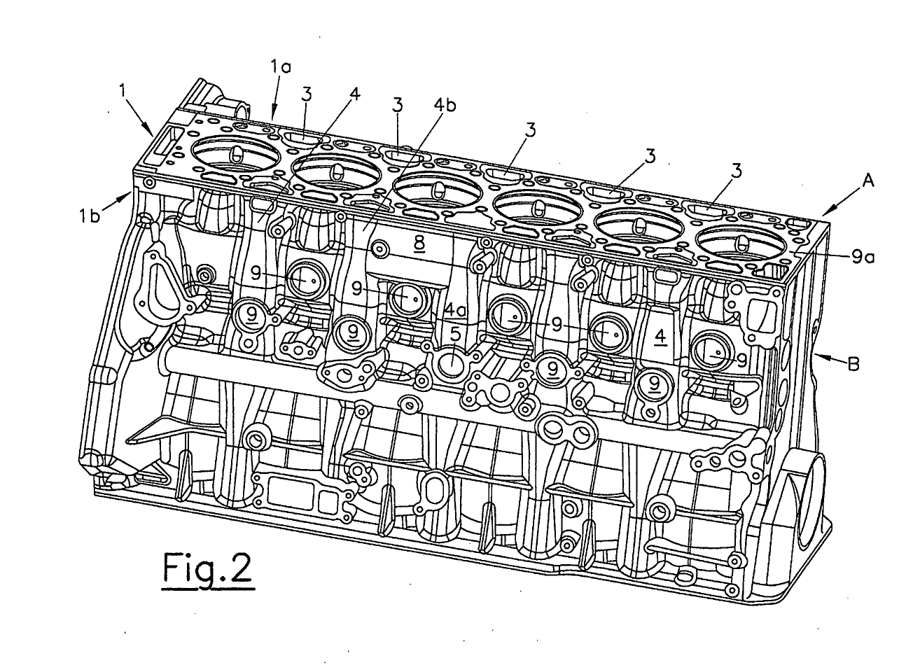

FIG. 2 shows the crankcase in a diagonal view without blow-by gas line;

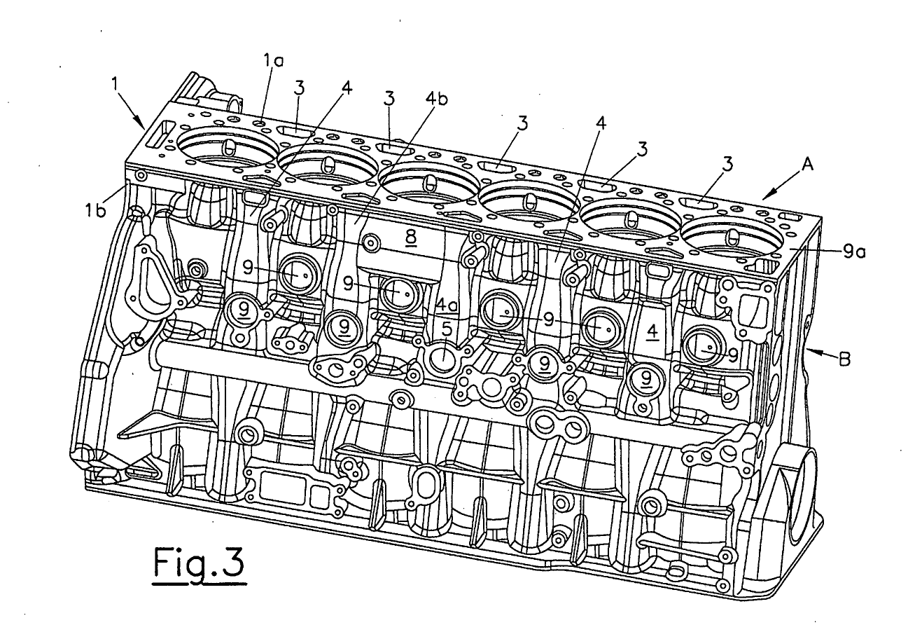

FIG. 3 shows the crankcase in a diagonal view in a second embodiment variant;

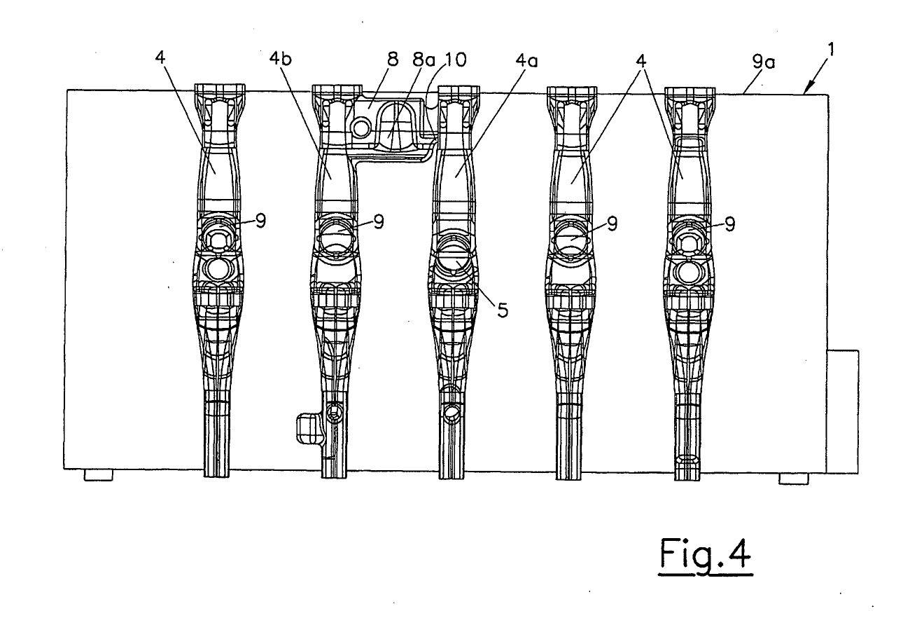

FIG. 4 shows the crankcase in a side view;

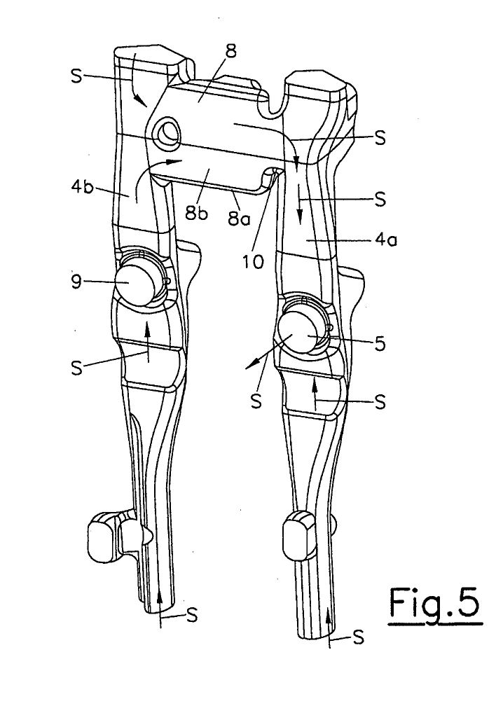

FIG. 5 shows two adjacent vertical reinforcements in a diagonal view;

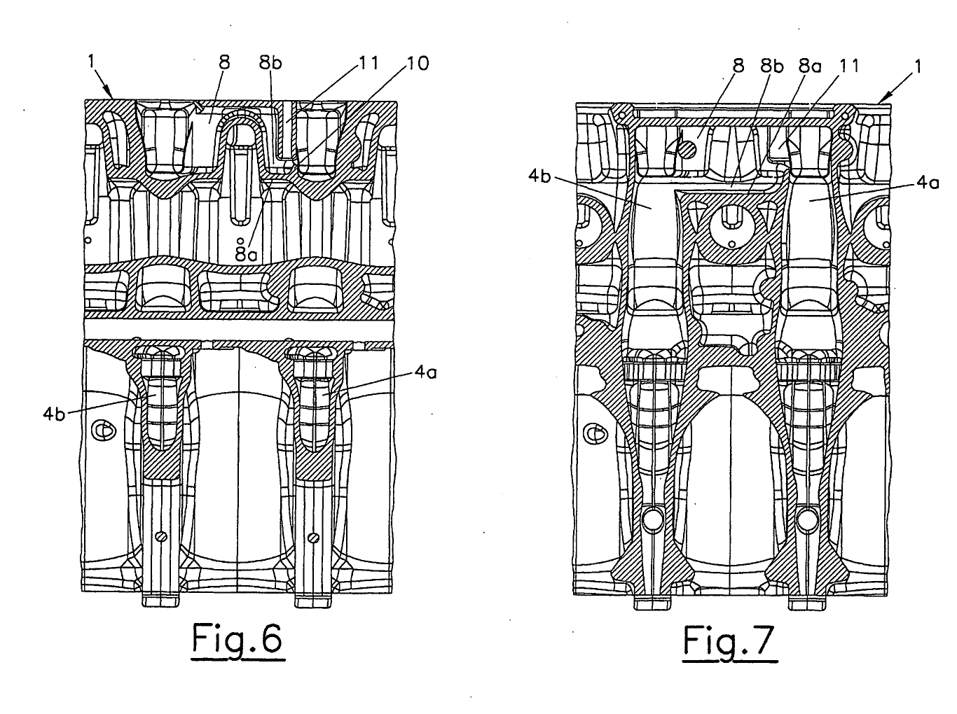

FIG. 6 shows the adjacent vertical reinforcements in a longitudinal section; and

FIG. 7 shows the vertical reinforcements in a further longitudinal section.

The crankcase 1 for a plurality of cylinders 2 situated in a row has a first group A and a second group B of hollow vertical reinforcements 3, 4, 4a, 4b situated in the area of main bearing planes and in the area of the side walls 1a, 1b. The first group A of vertical reinforcements 3 is situated in the area of a first longitudinal side 1a of the crankcase 1, and the second group B of hollow vertical reinforcements 4, 4a, 4b is situated in the area of a second longitudinal side 1b of the crankcase 1. The first group A of vertical reinforcements 3 is implemented as oil recirculation passages and is connected to oil recirculation channels (not shown in greater detail) of the cylinder head. The second group B of vertical reinforcements 4, 4a, 4b is implemented as blow-by passages and also has a flow connection to blow-by gas channels (not shown in greater detail) of the cylinder head. The oil recirculation channels and blow-by gas channels of the cylinder head originate from the valve actuation chamber. In order to achieve a separation between recirculating oil and blow-by gases, the mouths of the oil recirculation channels in the cylinder head are situated lower than the mouths of the blow-by gas channels.

A hollow vertical reinforcement 4a of the second group B, which is situated in the area of an engine central plane ε, has a connection 5 for a blow-by gas line 7 leading to an oil separator 6. The oil separator 6 is flanged on the crankcase 1. An exit channel (not shown in greater detail) of the oil separator 6 leads back to the crankcase 1 again.

FIG. 1 and FIG. 2 show an embodiment variant in which the vertical reinforcement 4a, which has the connection 5 for the blow-by gas line 7 is separated from the cylinder head except for an oil recirculation opening 8 in the area of the cylinder head sealing surface 9a. This prevents excessively large quantities of oil from reaching the blow-by gas line 7.

FIG. 3 shows an alternative embodiment variant in which the vertical reinforcement 4a is open toward the cylinder head. The flow interruption to the cylinder head can optionally be ensured by the cylinder head seal.

A connection channel 8, which connects the vertical reinforcements 4a, 4b to one another, is provided between the vertical reinforcement 4a having the connection 5 and an adjacent vertical reinforcement 4b. The blow-by gases thus flow in the vertical reinforcements 4a, 4b in the way shown by the arrows S in FIG. 5 out of the cylinder head and the crankcase through the connection 5 into the blow-by gas line 7. Cast openings, which are subsequently closed by lids, are identified by reference numeral 9.

The connection channel 8 has an oil separation edge 10, which prevents entrained oil from being introduced into the blow-by gas line 7, on its bottom side 8a in the area of the entry into the vertical reinforcement 4a having the connection 5. The connection channel 8 can be implemented in the area of its bottom side 8a as a collection chamber 8b for oil, so that oil held back by the oil separation edge 10 can drain into the adjacent hollow vertical reinforcement 4b in the direction of the crankcase. An oil recirculation line 11 can open into the oil collection chamber 8b of the connection channel 8 directly upstream from the oil separation edge 10. This oil recirculation line 11 is connected to a corresponding oil recirculation channel in the cylinder head, whose mouth is situated lower than the mouth of adjacent blow-by gas channels, which lead to the vertical reinforcements 4, 4a, 4b. In this way, the blow-by gases entering the vertical reinforcement 4a additionally entrain as few oil droplets as possible.

1-9. (canceled)

10. An internal combustion engine having a crankcase for a plurality of cylinders, which has hollow vertical reinforcements of the side walls of the crankcase in areas of main bearing planes, at least a part of the reinforcements being implemented as oil recirculation passages between cylinder head and crankcase, wherein at least one vertical reinforcement which conducts blow-by gas has a connection for a blow-by gas line leading to an oil separator.

11. The internal combustion engine according to claim 10, wherein a first group of vertical reinforcements is implemented as oil recirculation passages and a second group of vertical reinforcements is implemented as blow-by passages, so that the oil recirculation and the flow of blow-by gases occur essentially separately from one another.

12. The internal combustion engines according to claim 11, wherein the first group of vertical reinforcements is situated on a first longitudinal side of the crankcase and the second group of vertical reinforcements is situated on a second longitudinal side of the crankcase.

13. The internal combustion engine according to claim 10, wherein the first group of vertical reinforcements is connected to oil recirculation channels in the cylinder head and the second group of vertical reinforcements is connected to blow-by gas channels in the cylinder head, the mouths of the oil recirculation channels of the cylinder head being situated lower than the mouths of the blow-by gas channels.

14. The internal combustion engine according to claim 10, wherein the vertical reinforcement having the connection for the blow-by gas line has a flow connection via a connection channel to at least one adjacent vertical reinforcement.

15. The internal combustion engine according to claim 14, wherein the connection channel is situated in an area of a cylinder in the side wall of the crankcase.

16. The internal combustion engine according to claim 14, wherein the connection channel has an oil separation edge in the area of the vertical reinforcement having the connection on the bottom side farther away from the cylinder head.

17. The internal combustion engine according to claim 13, wherein the connection channel is implemented as an oil collection chamber, in order to conduct separated oil into the adjacent vertical reinforcement.

18. The internal combustion engine according to claim 10, wherein the vertical reinforcement having the connection is situated approximately in the area of an engine central plane.

19. The internal combustion engine according to claim 10, wherein the vertical reinforcement having the connection is separated from the cylinder head by a cylinder head seal in the area of the cylinder head sealing surface, except for an oil recirculation opening.

20. The internal combustion engine according to claim 10, wherein the vertical reinforcement having the connection is separated from the cylinder head by a cylinder head seal in the area of the cylinder head sealing surface.
